(19) United States
(12) Patent Application Publication
(10) Pub. No.: US 2023/0195773 A1
(43) Pub. Date: Jun. 22, 2023

(54) TEXT CLASSIFICATION METHOD, APPARATUS AND COMPUTER-READABLE STORAGE MEDIUM

(71) Applicant: PING AN TECHNOLOGY (SHENZHEN) CO., LTD., Shenzhen, Guangdong (CN)

(72) Inventors: Xiang Zhang, Shenzhen, Guangdong (CN); Xiuming Yu, Shenzhen, Guangdong (CN); Jinghua Liu, Shenzhen, Guangdong (CN); Wei Wang, Shenzhen, Guangdong (CN)

(21) Appl. No.: 17/613,483

(22) PCT Filed: Nov. 13, 2019
(86) PCT No.: PCT/CN2019/118010

§ 371 Date: Apr. 28, 2022

(30) Foreign Application Priority Data
Oct. 11, 2019 (CN) 201910967010.5

(51) Int. Cl. G06F 16/35; G06N 3/091; G06N 3/0464

(52) U.S. Cl. CPC G06F 16/355; G06N 3/091; G06N 3/0464

(57) ABSTRACT

The present application relates to artificial intelligence, and discloses a text classification method, including: preprocessing original text data to obtain a text vector; matching a tag to the text vector to obtain a tagged text vector and an untagged text vector; inputting the tagged text vector into a BERT model to obtain a word vector feature; training the untagged text vector with a convolution neural network model according to the word vector feature to obtain a virtually tagged text vector; and using a random forest model to perform multi-tag classification on the tagged text vector and the virtually tagged text vector to obtain a text classification result. The present application also provides a text classification apparatus and a computer-readable storage medium. The present application can realize accurate and efficient text classification.

The present application claims priority to Chinese Patent Application No. 201910967010.5 entitled “Text Classification Method, Apparatus and Computer-readable Storage Medium” filed on Oct. 11, 2019 with the Patent Office of China, which is incorporated herein by reference in its entirety.

### TECHNICAL FIELD

The present application relates to the technical field of artificial intelligence, more particularly, to a method, apparatus and computer-readable storage medium for tagged classification of text through deep learning.

### BACKGROUND

In the prior art, it is common to select 3 or 5 tags with the highest probability for multi-tag classification of text, wherein the number of tags has to be agreed in advance. In practice, however, a text may have no tags, in such a case, the information captured by the conventional method has a too low level to accurately identify tag and classify, leading to a low classification accuracy.

### SUMMARY

It is a major object of the present application to provide a method for subjecting original text data set to deep learning for tagged classification by providing herein a text classification method, apparatus and computer-readable storage medium.

To achieve the above object, the present application provides a text classification method, including: preprocessing original text data to obtain a text vector; matching a tag to the text vector to obtain a tagged text vector and an untagged text vector; inputting the tagged text vector into a BERT model to obtain a word vector feature; training the untagged text vector with a convolution neural network model according to the word vector feature to obtain a virtually tagged text vector; and using a random forest model to perform multi-tag classification on the tagged text vector and the virtually tagged text vector to obtain a text classification result.

Furthermore, to achieve the above object, the present application also provides a text classification apparatus, including a memory and a processor, wherein the memory stores a text classification program executable on the processor to implement the steps of: preprocessing original text data to obtain a text vector; matching a tag to the text vector to obtain a tagged text vector and an untagged text vector; inputting the tagged text vector into a BERT model to obtain a word vector feature; training the untagged text vector with a convolution neural network model according to the word vector feature to obtain a virtually tagged text vector; and using a random forest model to perform multi-tag classification on the tagged text vector and the virtually tagged text vector to obtain a text classification result.

Further, to achieve the above object, the present application also provides a computer-readable storage medium having stored thereon a text classification program executable by one or more processors to implement the steps of the text classification method as described above.

Preprocessing the original text data herein can effectively extract words which may belong to the original text data; furthermore, through vectorization and virtual tag matching, text classification and analysis can be performed efficiently and intelligently without loss of feature accuracy; finally, a pre-constructed convolution neural network model is used to train text tag to obtain a virtual tag; and a random forest model is used to perform multi-tag classification on a tagged text vector and a virtually tagged text vector to obtain a text classification result. Therefore, the text classification method, apparatus and computer-readable storage medium provided in the present application can achieve accurate and efficient text classification consistently.

### BRIEF DESCRIPTION OF THE ACCOMPANYING DRAWINGS

FIG. 1 is a schematic flow chart of a text classification method according to an embodiment of the present application;

FIG. 2 is a schematic diagram showing an internal structure of a text classification apparatus according to an embodiment of the present application;

FIG. 3 is a block diagram of a text classification program in the text classification apparatus according to an embodiment of the present application.

The object, features and advantages of the present application will be further described with reference to the accompanying drawings in conjunction with the embodiments.

### DETAILED DESCRIPTION OF ILLUSTRATED EMBODIMENTS

It should be understood that the particular embodiments described herein are illustrative only and are not limiting.

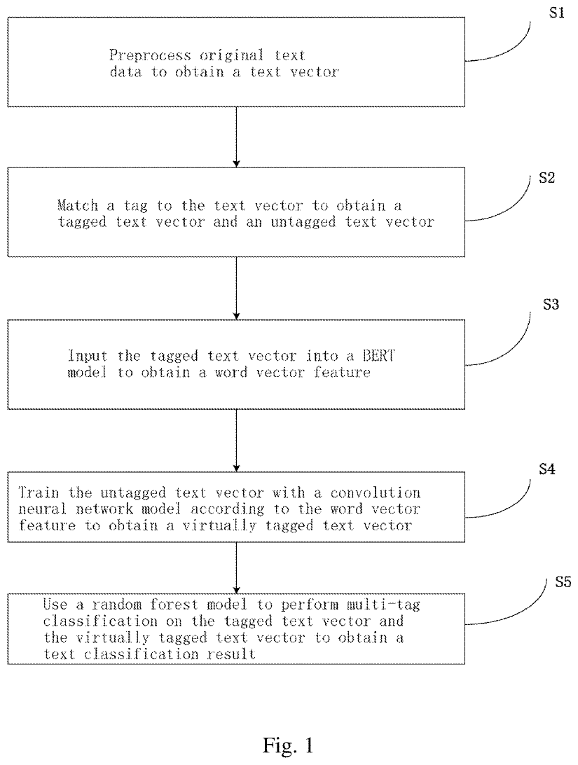

The present application provides a text classification method. Referring to FIG. 1, there is shown a schematic flow chart of a text classification method according to an embodiment of the present application. The method may be performed by an apparatus, which may be implemented by software and/or hardware.

In this embodiment, the text classification method includes the steps as follows.

In step S1, original text data input by a user are received, and the original text data are preprocessed to obtain a text vector.

Preferably, the preprocess includes subjecting the original text data to segmentation, removal of stopwords, de-duplication, and word-to-vector conversion.

Specifically, in a preferred embodiment herein, the original text data is subjected to segmentation to obtain second text data, wherein the segmentation is to segment each sentence in the original text data to obtain individual words.

As an example, in an embodiment herein, the original text data input by the user read “Peking University students go to Tsinghua to play badminton” and are subjected to the segmentation using a statistical-based segmentation method to obtain the second text data, the process of which will be described below.

For example, it is presumed that a combination of words into which a string that reads “Peking University students go to Tsinghua to play badminton” of the original text data may include “Peking University”, “University students”, “Peking University students”, “Tsinghua”, “go to”, “to play badminton”, “badminton”, “go to Tsinghua”, etc. In the entire corpus, “Peking University” is found more frequently than “Peking University students” and “University students”, so the statistical-based segmentation prefers “Peking University” as a segmentation result. And then, “to play” and “go to” cannot constitute a word, so “to play” is regarded as a segmentation result and “go to” is regarded as one, too. A combination of “Peking University” and “students” is more frequently found than a combination of “Peking University” and “stu-”, so “students” is taken as a segmentation result, “Peking University” as one, too, and so is “Tsinghua”; “badminton” is more frequently found than “badmin-” and/or “-ton”, so “badminton” is taken as a segmentation result; finally, the statistical-based segmentation method leads to a second segmentation result of the original text data that reads “Peking University students go to Tsinghua to play badminton” as “Peking University”, “students”, “go to”, “Tsinghua”, “to play”, “badminton”.

Preferably, in a possible embodiment herein, the second text data are further subjected to removal of stopwords to obtain third text data, wherein the stopwords are words which have no practical significance in the original text data and have no influence on the text classification but are found very frequently. The stopwords generally include commonly used pronouns, prepositions, etc. It has been proved that stopwords with no practical significance will reduce the effect of text classification, so one of the key steps in text data preprocessing is to remove stopwords. In an embodiment herein, the method for selecting stopwords is vocabulary filtering which tries to establish one-to-one matching between a pre-constructed vocabulary of stopwords and each word in the text, and if the matching is successful, the matched word is a stopword and has to be deleted. For example, the second text data after segmentation read “In the context of commodity economy, these enterprises will develop proper sales models depending on market conditions to expand market shares, stabilize sales prices, and improve product competitiveness. Therefore, feasibility analysis and marketing model research are necessary”.

The third text data obtained by removing the stopwords based on the second text data read “the context of commodity economy, enterprises develop proper sales models depending on market conditions, expand market shares, stabilize sales price, and improve product competitiveness. Therefore, feasibility analysis, and marketing model research.

Preferably, in a possible embodiment of the present application, the third text data are further subjected to de-duplication to obtain fourth text data.

In particular, the sources of collected text data are complicated, repeated text data may take up a large percent, which may reduce the classification accuracy. Therefore, in the embodiment of the present application, the text is first subjected to de-duplication using a Euclidean distance method before classification, and the formula thereof is as follows:

d=sqrt(Σⱼ₌₁ⁿ(w₁ⱼ−w₂ⱼ)²)

where w₁ⱼ and w₂ⱼ are two texts respectively, and d is the Euclidean distance. After calculation, a smaller Euclidean distance between two texts indicates a greater similarity between the two texts, and one of the two text data of which the Euclidean distance is less than a pre-set threshold value is deleted.

The text is represented by a series of characteristic words (keywords) after segmentation, stopwords removal and de-duplication. However, the data in this text form cannot be directly processed by the classification algorithm, but should be transformed into a numerical form. Therefore, it is necessary to calculate the weight of these characteristic words to characterize the importance of the characteristic words in the text.

Preferably, in a possible embodiment of the present application, the fourth text data are further subjected to the word-to-vector conversion to obtain the text vector. For example, the fourth text data read “Me and you”. A text vector [(1, 2), (0, 2), (3, 1)] are obtained through the word-to-vector conversion.

Preferably, through the word-to-vector conversion, any word in the fourth text data obtained after subjecting the original text data to segmentation, stopwords removal and de-duplication is represented by an N-dimensional matrix vector, wherein N is the total number of words contained in the fourth text data. In the present case, the words are initially vectorized according to the following formula:

$${v}^{i} = [ {v}_{1} , … , {v}_{j} , … {v}_{N} ] = \{ \begin{matrix}1 & j = i \\ 0 & j \neq i\end{matrix}$$

where i denotes a No. of a word, vⁱ denotes an N-dimensional matrix vector of the word i, it is assumed that there are s words in total, and vⱼ is a j^{th} element of the N-dimensional matrix vector.

In step S2, a tag is matched to the text vector to obtain a tagged text vector and an untagged text vector.

Preferably, matching a tag to the text vector to obtain a tagged text vector and an untagged text vector includes the steps as follows.

Step S201, the text vector are indexed. For example, the text vector [(1, 2), (0, 2), (3, 1)] contain three dimensions of data, i.e., (1, 2), (0, 2) and (3, 1). According to the three dimensions, an index is now established on each dimension, respectively, as a marker of the text vector on the corresponding dimension.

Step S202, according to the index, the text vector are queried, and its part of speech is marked. For example, from the index we can infer a characteristic of a text vector in a certain dimension, and the characteristic in the same dimension corresponds to the same part of speech. For example, “dog” and “knife” are both nouns, which means their indexes in a certain dimension (for example, the x dimension) are the same, both pointing to nouns. Accordingly, the part of speech of a certain text vector can be queried according to the index, and the part of speech of the text vector is tagged. For example, the fourth text data read “play”, and the text vector is [(0, 2), (7, 2), (10, 1)] after the conversion. Firstly, an index is established for [(0, 2), (7, 2), (10, 1)], the part of speech corresponding to the dimension is queried to be a verb according to the index, and the text vector [(0, 2), (7, 2), (10, 1)] is marked as a verb.

Step S203, a feature semantic network graph of the text is established according to the part of speech, a word frequency and a text frequency of the text are recorded, and the word frequency and the text frequency are subjected to weighted calculation and feature extraction to obtain the tags.

In particular, the text feature semantic network graph is a directed graph expressing text feature information by using texts and a semantic relationship between them, wherein a tag contained in the text vector is taken as a node of the graph, the semantic relationship between two a text vector is taken as a directed edge of the graph, the semantic relationship between the text vector in combination with word frequency information serves as a weight of the node, and the weight of the directed edge represents the importance of the relationship between a text vector in the text. The tag can be obtained by subjection the text vector to feature extraction through the text feature semantic network graph herein.

Step S204, the tag is matched to the text vector to obtain a tagged text vector, wherein if the tag obtained by the text vector after tag matching is null, the text vector is then determined as an untagged text vector.

In one embodiment of the present application, the tag matching means that the tag obtained by the text vector after the above-mentioned steps S201, S202 and S203 is matched with the original text vector. For example, if the tag of the text vector [(10, 2), (7, 8), (10, 4)] obtained after the above-mentioned steps S201, S202 and S203 is θ (the features of the tag can be selected and defined according to the requirements of the user, and the tag is represented herein as a letter for reference), then θ is matched to the text vector [(10, 2), (7, 8) and (10, 4)]. By the same reasoning, if the tag obtained by the text vector [(0, 0), (0, 0), (1, 4)] after the above-mentioned step S201, step S202 and step S203 is null, the vector [(0, 0), (0, 0), (1, 4)] is then determined as an untagged text vector.

Furthermore, the tag is matched to the text vector to obtain a tagged text vector, wherein if the tag obtained by the text vector after the above process is null, the text vector is then determined to be an untagged text vector.

In step S3, the tagged text vector is input into a BERT model to obtain a word vector feature.

In an embodiment of the present application, inputting the tagged text vector into a BERT model to obtain a word vector feature includes the following steps.

In step S301, the BERT model is established.

The BERT (Bidirectional Encoder Representations from Transformers) model described herein is a feature extraction model consisting of bi-directional transformers. Specifically, for example, there is a sentence x=x1, x2, . . . , xn, where x1, x2 and so on are specific characters in the sentence. The BERT model adds up input representations at three input layers, namely, Token Embedding, Segment Embedding, and Position Embedding, for each character in the sentence to obtain an input characterization, and optimizes the three input representations of the character by using a Masked Language Model and a Next Sentence Prediction as optimization targets, wherein the Masked Language Model and the Next Sentence Prediction are two typical algorithm types in the BERT model.

In step S302, the tagged text vector is input to the BERT model, and the BERT model is trained to obtain a word vector feature, including:

using a position code to add position information to the tagged text vector, and using an initial word vector to represent the tagged text vector to which the position information is added;

acquiring a part of speech of the tagged text vector, and converting the part of speech into a part-of-speech vector;

adding up the initial word vector and the part-of-speech vector to obtain vectors of the tagged text vector;

inputting the tagged text vector represented by the vectors into a Transformer model for data processing to obtain a word matrix of the tagged text vector; and

using the word matrix to predict whether two sentences in the tagged text vector are consecutive sentences, masked words in the two sentences and part-of-speech features of the masked words. By training the BERT model, the text vector input to the BERT model can predict a corresponding part-of-speech feature, and normalize the part-of-speech feature to obtain the word vector feature.

In step S4, the untagged text vector is trained with a convolution neural network model according to the word vector feature to obtain a virtually tagged text vector.

Preferably, in the present application, the following steps are employed to train the untagged text vector with the convolution neural network model according to the word vector feature, thereby obtaining the virtually tagged text vector.

The word vector feature is obtained by inputting the tagged text vector to the BERT model and training the BERT model, so the word vector feature contains the necessary features for the tag. Training the untagged text vector with the convolution neural network model according to the word vector can abstract the features of the word vector feature, so that the untagged text vector can be matched to an appropriate feature and then the virtual tag can be matched thereto. For example, in the previous steps, the untagged text vector is [(0, 2), (0, 0), (0, 4)], which is input into the convolution neural network model for training, and the word vector feature of the tagged text vector [(2, 2), (2, 2), (0, 4)] obtained through BERT model training is denoted as A. The convolution neural network model identifies the untagged text vector to be [(0, 2), (0, 0), (0, 4)], which has relevance to the word vector feature A. Therefore, according to the word vector feature A, the tagged text vector [(2, 2), (2, 2), (0, 4)] is found, and its tag is confirmed to be γ. The virtual tag is obtained based on the tag γ through normalization. The virtual tag is matched to the untagged text vector, resulting in a virtually tagged text vector.

In a preferred embodiment of the present application, the untagged text is trained through convolution layer processing of the convolution neural network model to obtain a trained convolution neural network model, and the training method herein is a gradient descent algorithm.

In step S5, a random forest model is used to perform multi-tag classification on the tagged text vector and the virtually tagged text vector to obtain a text classification result.

In particular, in one embodiment of the present application, the random forest algorithm extracts a plurality of sample subsets from the tagged text vector and the virtually tagged text vector by sampling with replacement through a bagging algorithm, and uses the sample subsets to train a plurality of decision tree models, and in the training process. In the training process, a random feature subspace method is used for reference, where some word vector features are extracted from a word vector set to split the decision tree, and finally multiple decision trees are integrated into an ensemble classifier, which is called the random forest. The algorithm process may include three parts, namely, the generation of the sample subset, the construction of the decision tree, and voting for a result, specifically as follows.

Step S501, generation of the sample subset.

Random forest is an ensemble classifier, and a certain sample subset has to be provided for each base classifier as the input variables of the base classifier. To take into account the evaluation model, multiple divisions of the sample set are possible, and in the embodiment of the present application, cross certification is employed to divide the data set, which divides the text to be trained into k (any natural number greater than zero) data subsets according to the number of characters; in each training, one of the data subsets is taken as a test set, the other data subsets are taken as training sets, and for k times, the test set and the training sets shift their roles.

Step S502, construction of the decision tree.

In the random forest, each base classifier is an independent decision tree. In the process of constructing the decision tree, a splitting rule is employed, seeking for an optimal feature to divide the sample and improving the accuracy of final classification. The decision tree of the random forest is constructed basically the same as the common decision tree, except that the decision tree of the random forest does not search the whole feature set, but randomly selects k (any natural number greater than zero) features to divide the sample. In the embodiment of the present application, each text vector is taken as the root of a decision tree, the above-mentioned feature of the text vector tag obtained by using the convolution neural network is taken as a sub-node of the decision tree, and a lower node thereof is the feature extracted subsequently for each tag. As such, each decision tree is trained.

The splitting rule refers to the specific rule involved in splitting the decision tree, for example, which feature to select, what the condition for splitting is, and when to terminate splitting. The generation of the decision tree is relatively arbitrary, and thus has to be regulated by the splitting rule to look better.

Step S503, voting for a result. The classification result of the random forest comes from the voting of each base classifier, i.e., the decision tree. The random forest treats all the basic classifiers equally, each decision tree gives a vote of a classification result, and the voting results of all the decision trees are gathered for counting, and the result with the most votes is the final result. As such, depending on the score of each sub-node (tag) of each decision tree (a text vector in want of tag classification), if the score of the tag is more than a threshold t set in the present application, the tag is believed to be able to interpret the text vector so as to obtain all the tags of the text vector. Herein, the threshold t is determined by adding up the voting results of all the classifiers in the decision tree and multiplying by 0.3.

Furthermore, the voting results obtained by the tagged text vector and the virtually tagged text vector through the random forest algorithm are sorted by weight, the voting results with the maximum weights are taken as classification keywords, and a semantic relationship among the classification keywords are employed to generate a classification result, namely, a text classification result of the text vector.

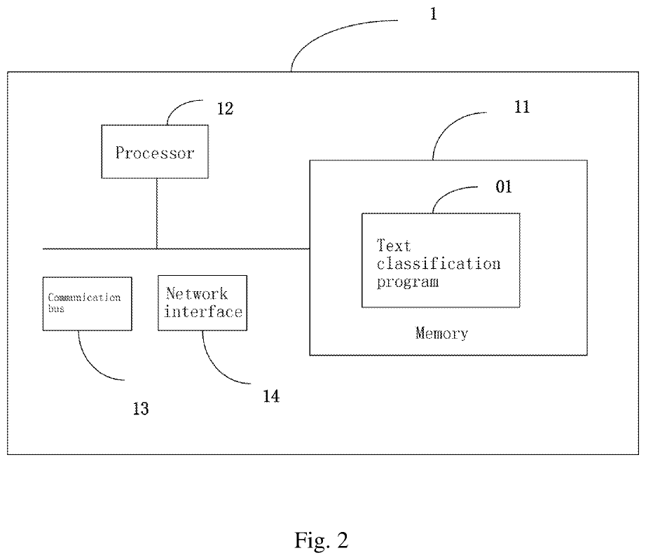

The invention also provides a text classification apparatus. Referring to FIG. 2, there is shown a schematic diagram of an internal structure of the text classification apparatus according to an embodiment of the present application.

In this embodiment, the text classification apparatus 1 may be a PC (Personal Computer), a terminal device such as a smart phone, a tablet computer and a portable computer, or a server. The text classification apparatus 1 includes at least a memory 11, a processor 12, a communication bus 13, and a network interface 14.

Herein, the memory 11 includes at least one type of readable storage medium including a flash memory, a hard disk, a multimedia card, a card-type memory (e.g., SD or DX memory, etc.), a magnetic memory, a magnetic disk, an optical disk, etc. The memory 11 may in some embodiments be an internal storage unit of the text classification apparatus 1, such as a hard disk of the text classification apparatus 1. The memory 11 may also be an external storage device of the text classification apparatus 1 in other embodiments, such as a plug-in hard disk, a smart media card (SMC), a secure digital (SD) card, or a Flash Card provided for the text classification apparatus 1. Furthermore, the memory 11 may include both an internal storage unit and an external storage device of the text classification apparatus 1. The memory 11 may be used not only to store application software installed in the text classification apparatus 1 and various types of data, such as codes of the text classification program 01, but also to temporarily store data that have been output or will be output.

The processor 12 may in some embodiments be a central processing unit (CPU), a controller, a microcontroller, a microprocessor or other data processing chip for running program code or processing data stored in the memory 11, for example, executing a text classification program 01 or the like.

The communication bus 13 is used to enable connection and communication among these components.

The network interface 14 may optionally include a standard wired interface, a wireless interface (e.g., a WI-FI interface), typically used for establishing communicative connections between the apparatus 1 and another electronic device.

Optionally, the apparatus 1 may further include a user interface, which may include a display and an input unit such as a keyboard, and the user interface may include optionally a standard wired interface and a wireless interface. Alternatively, in some embodiments, the display may be an LED display, a liquid crystal display, a touch-sensitive liquid crystal display, an OLED (Organic Light-Emitting Diode) touchpad, or the like. Where appropriate, the display may also be referred to as a display screen or a display unit for displaying information processed in the text classification apparatus 1 and for displaying a visual user interface.

FIG. 2 only shows a text classification apparatus 1 with components 11 to 14 and a text classification program 01, it is to be understood by a person skilled in the art that the structure shown in FIG. 1 does not limit the text classification apparatus 1, and fewer or more components than shown, or some components in combination, or a different arrangement of components may be included.

In the embodiment of the apparatus 1 shown in FIG. 2, a text classification program 01 is stored in the memory 11. When the processor 12 executes the text classification program 01 stored in the memory 11, the following steps are implemented.

In step S1, original text data input by a user are received, and the original text data are preprocessed to obtain a text vector.

Preferably, the preprocess includes subjecting the original text data to segmentation, removal of stopwords, de-duplication, and word-to-vector conversion.

Specifically, in a preferred embodiment herein, the original text data is subjected to segmentation to obtain second text data, wherein the segmentation is to segment each sentence in the original text data to obtain individual words.

As an example, in an embodiment herein, the original text data input by the user read “Peking University students go to Tsinghua to play badminton” and are subjected to the segmentation using a statistical-based segmentation method to obtain the second text data, the process of which will be described below.

For example, it is presumed that a combination of words into which a string that reads “Peking University students go to Tsinghua to play badminton” of the original text data may include “Peking University”, “University students”, “Peking University students”, “Tsinghua”, “go to”, “to play badminton”, “badminton”, “go to Tsinghua”, etc. In the entire corpus, “Peking University” is found more frequently than “Peking University students” and “University students”, so the statistical-based segmentation prefers “Peking University” as a segmentation result. And then, “to play” and “go to” cannot constitute a word, so “to play” is regarded as a segmentation result and “go to” is regarded as one, too. A combination of “Peking University” and “students” is more frequently found than a combination of “Peking University” and “stu-”, so “students” is taken as a segmentation result, “Peking University” as one, too, and so is “Tsinghua”; “badminton” is more frequently found than “badmin-” and/or “-ton”, so “badminton” is taken as a segmentation result; finally, the statistical-based segmentation method leads to a second segmentation result of the original text data that reads “Peking University students go to Tsinghua to play badminton” as “Peking University”, “students”, “go to”, “Tsinghua”, “to play”, “badminton”.

Preferably, in a possible embodiment herein, the second text data are further subjected to removal of stopwords to obtain third text data, wherein the stopwords are words which have no practical significance in the original text data and have no influence on the text classification but are found very frequently. The stopwords generally include commonly used pronouns, prepositions, etc. It has been proved that stopwords with no practical significance will reduce the effect of text classification, so one of the key steps in text data preprocessing is to remove stopwords. In an embodiment herein, the method for selecting stopwords is vocabulary filtering which tries to establish one-to-one matching between a pre-constructed vocabulary of stopwords and each word in the text, and if the matching is successful, the matched word is a stopword and has to be deleted. For example, the second text data after segmentation read “In the context of commodity economy, these enterprises will develop proper sales models depending on market conditions to expand market shares, stabilize sales prices, and improve product competitiveness. Therefore, feasibility analysis and marketing model research are necessary”.

The third text data obtained by removing the stopwords based on the second text data read “the context of commodity economy, enterprises develop proper sales models depending on market conditions, expand market shares, stabilize sales price, and improve product competitiveness. Therefore, feasibility analysis, and marketing model research.

Preferably, in a possible embodiment of the present application, the third text data are further subjected to de-duplication to obtain fourth text data.

In particular, the sources of collected text data are complicated, repeated text data may take up a large percent, which may reduce the classification accuracy. Therefore, in the embodiment of the present application, the text is first subjected to de-duplication using a Euclidean distance method before classification, and the formula thereof is as follows:

d=sqrt(Σⱼ₌₁ⁿ(w₁ⱼ−w₂ⱼ)²)

where w₁ⱼ and w₂ⱼ are two texts respectively, and d is the Euclidean distance. After calculation, a smaller Euclidean distance between two texts indicates a greater similarity between the two texts, and one of the two text data of which the Euclidean distance is less than a pre-set threshold value is deleted.

The text is represented by a series of characteristic words (keywords) after segmentation, stopwords removal and de-duplication. However, the data in this text form cannot be directly processed by the classification algorithm, but should be transformed into a numerical form. Therefore, it is necessary to calculate the weight of these characteristic words to characterize the importance of the characteristic words in the text.

Preferably, in a possible embodiment of the present application, the fourth text data are further subjected to the word-to-vector conversion to obtain the text vector. For example, the fourth text data read “Me and you”. A text vector [(1, 2), (0, 2), (3, 1)] are obtained through the word-to-vector conversion.

Preferably, through the word-to-vector conversion, any word in the fourth text data obtained after subjecting the original text data to segmentation, stopwords removal and de-duplication is represented by an N-dimensional matrix vector, wherein N is the total number of words contained in the fourth text data. In the present case, the words are initially vectorized according to the following formula:

$${v}^{i} = [ {v}_{1} , … , {v}_{j} , … {v}_{N} ] = \{ \begin{matrix}1 & j = i \\ 0 & j \neq i\end{matrix}$$

where i denotes a No. of a word, vⁱ denotes an N-dimensional matrix vector of the word i, it is assumed that there are s words in total, and vⱼ is a j^{th} element of the N-dimensional matrix vector.

In step S2, a tag is matched to the text vector to obtain a tagged text vector and an untagged text vector.

Preferably, matching a tag to the text vector to obtain a tagged text vector and an untagged text vector includes the steps as follows. Step S201, the text vector are indexed. For example, the text vector [(1, 2), (0, 2), (3, 1)] contain three dimensions of data, i.e., (1, 2), (0, 2) and (3, 1). According to the three dimensions, an index is now established on each dimension, respectively, as a marker of the text vector on the corresponding dimension.

Step S202, according to the index, the text vector are queried, and its part of speech is marked. For example, from the index we can infer a characteristic of a text vector in a certain dimension, and the characteristic in the same dimension corresponds to the same part of speech. For example, “dog” and “knife” are both nouns, which means their indexes in a certain dimension (for example, the x dimension) are the same, both pointing to nouns. Accordingly, the part of speech of a certain text vector can be queried according to the index, and the part of speech of the text vector is tagged. For example, the fourth text data read “play”, and the text vector is [(0, 2), (7, 2), (10, 1)] after the conversion. Firstly, an index is established for [(0, 2), (7, 2), (10, 1)], the part of speech corresponding to the dimension is queried to be a verb according to the index, and the text vector [(0, 2), (7, 2), (10, 1)] is marked as a verb. Step S203, a feature semantic network graph of the text is established according to the part of speech, a word frequency and a text frequency of the text are recorded, and the word frequency and the text frequency are subjected to weighted calculation and feature extraction to obtain the tags.

In particular, the text feature semantic network graph is a directed graph expressing text feature information by using texts and a semantic relationship between them, wherein a tag contained in the text vector is taken as a node of the graph, the semantic relationship between two a text vector is taken as a directed edge of the graph, the semantic relationship between the text vector in combination with word frequency information serves as a weight of the node, and the weight of the directed edge represents the importance of the relationship between a text vector in the text. The tag can be obtained by subjection the text vector to feature extraction through the text feature semantic network graph herein.

Step S204, the tag is matched to the text vector to obtain a tagged text vector, wherein if the tag obtained by the text vector after tag matching is null, the text vector is then determined as an untagged text vector.

In one embodiment of the present application, the tag matching means that the tag obtained by the text vector after the above-mentioned steps S201, S202 and S203 is matched with the original text vector. For example, if the tag of the text vector [(10, 2), (7, 8), (10, 4)] obtained after the above-mentioned steps S201, S202 and S203 is θ (the features of the tag can be selected and defined according to the requirements of the user, and the tag is represented herein as a letter for reference), then θ is matched to the text vector [(10, 2), (7, 8) and (10, 4)]. By the same reasoning, if the tag obtained by the text vector [(0, 0), (0, 0), (1, 4)] after the above-mentioned step S201, step S202 and step S203 is null, the vector [(0, 0), (0, 0), (1, 4)] is then determined as an untagged text vector.

Furthermore, the tag is matched to the text vector to obtain a tagged text vector, wherein if the tag obtained by the text vector after the above process is null, the text vector is then determined to be an untagged text vector.

In step S3, the tagged text vector is input into a BERT model to obtain a word vector feature.

In an embodiment of the present application, inputting the tagged text vector into a BERT model to obtain a word vector feature includes the following steps.

In step S301, the BERT model is established.

The BERT (Bidirectional Encoder Representations from Transformers) model described herein is a feature extraction model consisting of bi-directional transformers. Specifically, for example, there is a sentence x=x1, x2, . . . , xn, where x1, x2 and so on are specific characters in the sentence. The BERT model adds up input representations at three input layers, namely, Token Embedding, Segment Embedding, and Position Embedding, for each character in the sentence to obtain an input characterization, and optimizes the three input representations of the character by using a Masked Language Model and a Next Sentence Prediction as optimization targets, wherein the Masked Language Model and the Next Sentence Prediction are two typical algorithm types in the BERT model.

In step S302, the tagged text vector is input to the BERT model, and the BERT model is trained to obtain a word vector feature, including:

using a position code to add position information to the tagged text vector, and using an initial word vector to represent the tagged text vector to which the position information is added;

acquiring a part of speech of the tagged text vector, and converting the part of speech into a part-of-speech vector;

adding up the initial word vector and the part-of-speech vector to obtain vectors of the tagged text vector;

inputting the tagged text vector represented by the vectors into a Transformer model for data processing to obtain a word matrix of the tagged text vector; and

using the word matrix to predict whether two sentences in the tagged text vector are consecutive sentences, masked words in the two sentences and part-of-speech features of the masked words. By training the BERT model, the text vector input to the BERT model can predict a corresponding part-of-speech feature, and normalize the part-of-speech feature to obtain the word vector feature.

In step S4, the untagged text vector is trained with a convolution neural network model according to the word vector feature to obtain a virtually tagged text vector.

Preferably, in the present application, the following steps are employed to train the untagged text vector with the convolution neural network model according to the word vector feature, thereby obtaining the virtually tagged text vector.

The word vector feature is obtained by inputting the tagged text vector to the BERT model and training the BERT model, so the word vector feature contains the necessary features for the tag. Training the untagged text vector with the convolution neural network model according to the word vector can abstract the features of the word vector feature, so that the untagged text vector can be matched to an appropriate feature and then the virtual tag can be matched thereto. For example, in the previous steps, the untagged text vector is [(0, 2), (0, 0), (0, 4)], which is input into the convolution neural network model for training, and the word vector feature of the tagged text vector [(2, 2), (2, 2), (0, 4)] obtained through BERT model training is denoted as A. The convolution neural network model identifies the untagged text vector to be [(0, 2), (0, 0), (0, 4)], which has relevance to the word vector feature A. Therefore, according to the word vector feature A, the tagged text vector [(2, 2), (2, 2), (0, 4)] is found, and its tag is confirmed to be γ. The virtual tag is obtained based on the tag γ through normalization. The virtual tag is matched to the untagged text vector, resulting in a virtually tagged text vector.

In a preferred embodiment of the present application, the untagged text is trained through convolution layer processing of the convolution neural network model to obtain a trained convolution neural network model, and the training method herein is a gradient descent algorithm.

In step S5, a random forest model is used to perform multi-tag classification on the tagged text vector and the virtually tagged text vector to obtain a text classification result.

In particular, in one embodiment of the present application, the random forest algorithm extracts a plurality of sample subsets from the tagged text vector and the virtually tagged text vector by sampling with replacement through a bagging algorithm, and uses the sample subsets to train a plurality of decision tree models, and in the training process. In the training process, a random feature subspace method is used for reference, where some word vector features are extracted from a word vector set to split the decision tree, and finally multiple decision trees are integrated into an ensemble classifier, which is called the random forest. The algorithm process may include three parts, namely, the generation of the sample subset, the construction of the decision tree, and voting for a result, specifically as follows.

Step S501, generation of the sample subset.

Random forest is an ensemble classifier, and a certain sample subset has to be provided for each base classifier as the input variables of the base classifier. To take into account the evaluation model, multiple divisions of the sample set are possible, and in the embodiment of the present application, cross certification is employed to divide the data set, which divides the text to be trained into k (any natural number greater than zero) data subsets according to the number of characters; in each training, one of the data subsets is taken as a test set, the other data subsets are taken as training sets, and for k times, the test set and the training sets shift their roles.

Step S502, construction of the decision tree.

In the random forest, each base classifier is an independent decision tree. In the process of constructing the decision tree, a splitting rule is employed, seeking for an optimal feature to divide the sample and improving the accuracy of final classification. The decision tree of the random forest is constructed basically the same as the common decision tree, except that the decision tree of the random forest does not search the whole feature set, but randomly selects k (any natural number greater than zero) features to divide the sample. In the embodiment of the present application, each text vector is taken as the root of a decision tree, the above-mentioned feature of the text vector tag obtained by using the convolution neural network is taken as a sub-node of the decision tree, and a lower node thereof is the feature extracted subsequently for each tag. As such, each decision tree is trained.

The splitting rule refers to the specific rule involved in splitting the decision tree, for example, which feature to select, what the condition for splitting is, and when to terminate splitting. The generation of the decision tree is relatively arbitrary, and thus has to be regulated by the splitting rule to look better.

Step S503, voting for a result. The classification result of the random forest comes from the voting of each base classifier, i.e., the decision tree. The random forest treats all the basic classifiers equally, each decision tree gives a vote of a classification result, and the voting results of all the decision trees are gathered for counting, and the result with the most votes is the final result. As such, depending on the score of each sub-node (tag) of each decision tree (a text vector in want of tag classification), if the score of the tag is more than a threshold t set in the present application, the tag is believed to be able to interpret the text vector so as to obtain all the tags of the text vector. Herein, the threshold t is determined by adding up the voting results of all the classifiers in the decision tree and multiplying by 0.3.

Furthermore, the voting results obtained by the tagged text vector and the virtually tagged text vector through the random forest algorithm are sorted by weight, the voting results with the maximum weights are taken as classification keywords, and a semantic relationship among the classification keywords are employed to generate a classification result, namely, a text classification result of the text vector.

Alternatively, in other embodiments, the text classification program may be divided into one or more modules stored in the memory 11 and executed by one or more processors (the processor 12 in this embodiment) to implement the present application, where the module herein refers to a series of computer program instruction segments capable of performing a particular function to describe the execution process of the text classification program in the text classification apparatus.

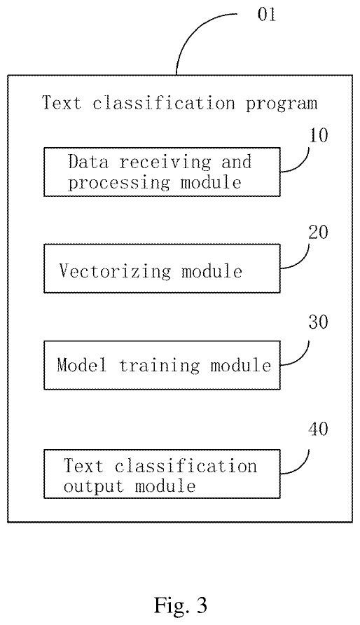

For example, referring to FIG. 3, there is shown a schematic diagram of program modules of a text classification program in an embodiment of the text classification apparatus of the present application, wherein the text classification program can be divided into a data receiving and processing module 10, a vectorizing module 20, a model training module 30 and a text classification output module 40. As an example,

the data receiving and processing module 10 is configured for receiving original text data, and preprocess the original text data to obtain fourth text data through segmentation and stopwords removal;

the vectorizing module 20 is configured for vectorizing the fourth text data to obtain a text vector;

the model training module 30 is configured for inputting the text vector into a pre-constructed text classification model for training and obtain a training value, and if the training value is less than a pre-set threshold value, letting the convolution neural network model exit the training; and

the text classification output module 40 is configured for receiving original text data input by a user, preprocessing, vectorizing and vector-encoding the original text data, inputting to the convolutional neural network model to generate a text classification result, and outputting the text classification result.

The data receiving and processing module 10, the vectorizing module 20, the model training module 30, the text classification output module 40 and other program modules are executed to achieve substantially the same functions or steps as the above-mentioned embodiments, and the description thereof will not be repeated here.

In addition, the embodiment of the present application also provides a computer-readable storage medium having stored thereon a text classification program executable by one or more processors to:

receive original text data, and preprocess the original text data to obtain fourth text data through segmentation and stopwords removal;

vectorize the fourth text data to obtain a text vector;

input the text vector into a pre-constructed text classification model for training and obtain a training value, and if the training value is less than a pre-set threshold value, let the convolution neural network model exit the training; and

receive original text data input by a user, preprocess, vectorize and vector-encode the original text data, input to the convolutional neural network model to generate a text classification result, and output the text classification result.

It should be noted that the above-mentioned serial numbers of the embodiments of the present application are merely for the purpose of description and do not represent the advantages and disadvantages of the embodiments. Also herein, the terms “include”, “comprise”, or any other variation thereof, are intended to cover a non-exclusive inclusion, such that a process, apparatus, article, or method that includes a list of elements does not include only those elements but may include other elements not expressly listed or inherent to such process, apparatus, article, or method. An element proceeded by “including one . . . ” does not, without more constraints, preclude the existence of additional identical elements in the process, apparatus, article, or method that includes the element.

From the description of the embodiments given above, it will be clear to a person skilled in the art that the method of the embodiments described above can be implemented by means of software plus a necessary general hardware platform, but of course also by means of hardware, the former in many cases being a better embodiment. Based on such an understanding, the technical solution of the present application, either substantial or in a contribution to the prior art, can be embodied in the form of a software product, wherein the computer software product is stored in a storage medium, such as a ROM/RAM, a magnetic diskette, and an optical disk, as stated above, and includes a plurality of instructions for enabling a terminal device, which can be a mobile phone, a computer, a server, or a network device, to execute the method according to various embodiments of the present application.

The above-mentioned embodiments are merely preferred embodiments of the present application, and do not limit the scope of the present application. Any equivalent structural or process changes made based on the disclosure of the description and the drawings of the present application, or direct or indirect use thereof in other relevant technical fields are likewise included in the scope of the present application.

What is claimed is:

1. A text classification method, comprising:
preprocessing original text data to obtain a text vector;
matching a tag to the text vector to obtain a tagged text vector and an untagged text vector;
inputting the tagged text vector into a BERT model to obtain a word vector feature;
training the untagged text vector with a convolution neural network model according to the word vector feature to obtain a virtually tagged text vector; and
using a random forest model to perform multi-tag classification on the tagged text vector and the virtually tagged text vector to obtain a text classification result.

2. The text classification method according to claim 1, wherein preprocessing original text data to obtain a text vector comprises:
segmenting the original text data to obtain second text data;
removing stopwords from the second text data to obtain third text data;
de-duplicating the third text data to obtain fourth text data; and
vectorizing the fourth text data to obtain the text vector.

3. The text classification method according to claim 1, wherein the BERT model comprises an input layer, a vector layer, a classification layer, and a coding layer; and
inputting the tagged text vector into a BERT model to obtain a word vector feature comprises:
acquiring a part of speech of the tagged text vector, and converting the part of speech into a part-of-speech vector;
inputting the part-of-speech vector corresponding to the tagged text vector into the BERT model for data processing to obtain a word matrix of the tagged text vector; and
obtaining the word vector feature of the tagged text vector according to the word matrix of the tagged text vector.

4. The text classification method according to claim 1, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

5. The text classification method according to claim 2, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

6. The text classification method according to claim 3, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

7. The text classification method according to claim 4, comprising: after obtaining the virtually tagged text vector, generating the random forest model; wherein,
generating the random forest model comprises:
extracting a plurality of sample subsets from the tagged text vector and the virtually tagged text vector by sampling with replacement through a bagging algorithm, and using the sample subsets to train a decision tree model; and
taking the decision tree model as a base classifier, and dividing the sample subsets according to a pre-set splitting rule so as to generate a random forest model composed of a plurality of the decision tree models.

8. A text classification apparatus, comprising a memory and a processor, the memory having stored thereon a text classification program executable on the processor to perform the steps of:
preprocessing original text data to obtain a text vector;
matching a tag to the text vector to obtain a tagged text vector and an untagged text vector;
inputting the tagged text vector into a BERT model to obtain a word vector feature;
training the untagged text vector with a convolution neural network model according to the word vector feature to obtain a virtually tagged text vector; and
using a random forest model to perform multi-tag classification on the tagged text vector and the virtually tagged text vector to obtain a text classification result.

9. The text classification apparatus according to claim 8, wherein preprocessing original text data to obtain a text vector comprises:
segmenting the original text data to obtain second text data;
removing stopwords from the second text data to obtain third text data;
de-duplicating the third text data to obtain fourth text data; and
vectorizing the fourth text data to obtain the text vector.

10. The text classification apparatus according to claim 8, wherein the BERT model comprises an input layer, a vector layer, a classification layer, and a coding layer; and
inputting the tagged text vector into a BERT model to obtain a word vector feature comprises:
acquiring a part of speech of the tagged text vector, and converting the part of speech into a part-of-speech vector;
inputting the part-of-speech vector corresponding to the tagged text vector into the BERT model for data processing to obtain a word matrix of the tagged text vector; and
obtaining the word vector feature of the tagged text vector according to the word matrix of the tagged text vector.

11. The text classification apparatus according to claim 8, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

12. The text classification apparatus according to claim 9, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

13. The text classification apparatus according to claim 10, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

14. The text classification apparatus according to claim 11, comprising: after obtaining the virtually tagged text vector, generating the random forest model; wherein,
generating the random forest model comprises:
extracting a plurality of sample subsets from the tagged text vector and the virtually tagged text vector by sampling with replacement through a bagging algorithm, and using the sample subsets to train a decision tree model; and
taking the decision tree model as a base classifier, and dividing the sample subsets according to a pre-set splitting rule so as to generate a random forest model composed of a plurality of the decision tree models.

15. A computer-readable storage medium having a text classification program stored thereon, the text classification program being executable by one or more processors to perform the steps of:
preprocessing original text data to obtain a text vector;
matching a tag to the text vector to obtain a tagged text vector and an untagged text vector;
inputting the tagged text vector into a BERT model to obtain a word vector feature;
training the untagged text vector with a convolution neural network model according to the word vector feature to obtain a virtually tagged text vector; and
using a random forest model to perform multi-tag classification on the tagged text vector and the virtually tagged text vector to obtain a text classification result.

16. The computer-readable storage medium according to claim 15, wherein preprocessing original text data to obtain a text vector comprises:
segmenting the original text data to obtain second text data;
removing stopwords from the second text data to obtain third text data;
de-duplicating the third text data to obtain fourth text data; and
vectorizing the fourth text data to obtain the text vector.

17. The computer-readable storage medium according to claim 15, wherein the BERT model comprises an input layer, a vector layer, a classification layer, and a coding layer; and
inputting the tagged text vector into a BERT model to obtain a word vector feature comprises:
acquiring a part of speech of the tagged text vector, and converting the part of speech into a part-of-speech vector;
inputting the part-of-speech vector corresponding to the tagged text vector into the BERT model for data processing to obtain a word matrix of the tagged text vector; and
obtaining the word vector feature of the tagged text vector according to the word matrix of the tagged text vector.

18. The computer-readable storage medium according to claim 15, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

19. The computer-readable storage medium according to claim 16, wherein training the untagged text vector with a convolution neural network model according to the word vector feature to obtain a virtually tagged text vector comprises:
inputting the untagged text vector into a convolution layer of the convolution neural network model to train the convolution neural network model, thereby obtaining a trained convolution neural network model;
inputting the word vector feature into the trained convolution neural network model to obtain a feature vector;
normalizing the feature vector to obtain a virtual tag; and
matching the virtual tag to the untagged text vector to obtain the virtually tagged text vector.

20. The computer-readable storage medium according to claim 19, comprising after obtaining the virtually tagged text vector, generating the random forest model; wherein,
generating the random forest model comprises:
extracting a plurality of sample subsets from the tagged text vector and the virtually tagged text vector by sampling with replacement through a bagging algorithm, and using the sample subsets to train a decision tree model; and
taking the decision tree model as a base classifier, and dividing the sample subsets according to a pre-set splitting rule so as to generate a random forest model composed of a plurality of the decision tree models.
